(19) United States
(12) Patent Application Publication
(10) Pub. No.: US 2023/0041941 A1
(43) Pub. Date: Feb. 9, 2023

(54) METHODS AND SYSTEMS OF MITIGATING HIGH-SPEED JET NOISE

(71) Applicant: University of Kansas, Lawrence, KS (US)

(72) Inventors: Saeed FAROKHI, San Diego, CA (US); Ray TAGHAVI, Lawrence, KS (US); Zhi WANG, Lawrence, KS (US); Huixuan WU, Lawrence, KS (US); Zhongquan ZHENG, Logan, UT (US)

(21) Appl. No.: 17/790,599

(22) PCT Filed: Dec. 31, 2020
(86) PCT No.: PCT/US2020/067631

§ 371 Date: Jul. 1, 2022

Related U.S. Application Data
(60) Provisional application No. 62/956,978, filed on Jan. 3, 2020.

(51) Int. Cl. F02K 1/46; F01N 1/14; F02K 1/34

(52) U.S. Cl. CPC F02K 1/46; F01N 1/14; B64D 33/06; F05D 2220/323; F05D 2260/963

(57) ABSTRACT

A method of reducing noise from a high-speed, including supersonic, jet, the method includes providing the high-speed or supersonic jet in a longitudinal flow direction; and inducing a rotation of a swirl layer of the high-speed or supersonic jet around a longitudinal direction of the jet and on the jet boundary so as to promote mixing of the high-speed or supersonic jet with surrounding air.

### PRIORITY CLAIM

The present application claims priority to and the benefit of U.S. Provisional Patent Application No. 62/956,978 filed Jan. 3, 2020 entitled METHODS AND SYSTEMS OF MITIGATING JET NOZZLE NOISE, the disclosure of which is incorporated herein by reference in its entirety.

### GOVERNMENTAL RIGHTS

This invention was made with government support under Contract No. W912HQ19P0006 awarded by the Department of Defense. The government has certain rights in the invention.

### BACKGROUND OF THE DISCLOSURE

Noise generated by high-performance military aircraft is dominated by jet noise. The takeoff from an aircraft carrier involves supersonic jet noise that has proven to be a challenge to mitigate/control. The primary subsonic jet noise mitigation approaches have proven to be inadequate in supersonic jet noise mitigation. Additionally, many devices incorporated into the engine or nozzle design to quiet the jet include an unacceptable penalty, such as thrust loss.

Supersonic jet noise comprises three components: a turbulent mixing noise, a broadband shock-associated noise (BBSAN), and screech tones. Turbulent mixing noise is caused by the turbulence in the mixing or shear layer of the jet and is the dominant noise source in the downstream direction. Broadband shock associated noise is generated by turbulent eddies passing through the shock-cell system of an under-expanded supersonic jet plume. Finally, screech is a resonant feedback phenomenon created by the interaction of large-scale turbulent structures and shock cells.

### SUMMARY

In some embodiments, a method of reducing noise from a high-speed, including supersonic, jet, the method includes providing the high-speed or supersonic jet in a longitudinal flow direction; and inducing a rotation of a swirl layer of the high-speed or supersonic jet around a longitudinal direction of the jet and on the jet boundary so as to promote mixing of the high-speed or supersonic jet with surrounding air.

In some embodiments, a device for reducing noise from a supersonic jet includes a jet nozzle and a swirl mechanism. The jet nozzle has an exit therethrough where the exit has a longitudinal axis and is configured to allow fluid communication therethrough. The swirl mechanism is positioned on an inner surface of the jet nozzle and is configured to induce a rotation of a swirl layer of a gas around a longitudinal direction of a fluid flowing through the exit in the longitudinal direction.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a side cross-sectional view of an exhaust nozzle, according to at least one embodiment of the present disclosure;

FIG. 2 is a side cross-sectional view of an exhaust nozzle with a swirl layer induced by swirl vanes including hot gases, according to at least one embodiment of the present disclosure;

FIG. 3 is a side cross-sectional view of an exhaust nozzle with an outer swirl layer induced by swirl vanes including cold gases, according to at least one embodiment of the present disclosure;

FIG. 4 is a side cross-sectional view of an exhaust nozzle with an outer channel, according to at least one embodiment of the present disclosure;

FIG. 5 is a side cross-sectional view of an exhaust nozzle with a plurality of vanes, according to at least one embodiment of the present disclosure;

FIG. 6 is a top schematic view of a plurality of angled vanes, according to at least one embodiment of the present disclosure;

FIGS. 7-1 and 7-2 are perspective views of exhaust nozzles with a lower and higher solidity cascade of swirl vanes, according to at least one embodiment of the present disclosure;

FIGS. 8-1 and 8-2 are end views of exhaust nozzles with movable vanes, according to at least one embodiment of the present disclosure;

FIGS. 9-1 and 9-2 are schematic representations of movable vanes, according to at least one embodiment of the present disclosure;

FIGS. 10-1 and 10-2 are end views of jet engine pairs with entrained swirl layers, according to at least one embodiment of the present disclosure;

FIG. 11 is a side cross-sectional view of an exhaust nozzle with a plurality of fluidic actuators, according to at least one embodiment of the present disclosure;

FIG. 12 is a side cross-sectional view of an adaptive cycle engine with a plurality of vanes, according to at least one embodiment of the present disclosure;

FIG. 13 is a graph illustrating experimental measurements at 90° from a jet flow direction, according to at least one embodiment of the present disclosure;

FIG. 14 is a graph illustrating experimental measurements at 120° from a jet flow direction, according to at least one embodiment of the present disclosure;

FIG. 15 is a graph illustrating experimental measurements at 140° from a jet flow direction, according to at least one embodiment of the present disclosure;

FIG. 16 is a graph illustrating experimental measurements at 150° from a jet flow direction, according to at least one embodiment of the present disclosure;

FIG. 17 is a graph comparing experimental measurements of swirl vanes at different pitch angles measured at 120° from a jet flow direction, according to at least one embodiment of the present disclosure; and

FIG. 18 is a graph comparing experimental measurements of swirl vanes at different pitch angles measured at 140° from a jet flow direction, according to at least one embodiment of the present disclosure.

### DETAILED DESCRIPTION

This disclosure generally relates to devices, systems, and methods for reducing and/or mitigating jet noise emanating from aircraft engine nozzles. More particularly, the present disclosure relates to a centrifugal instability mechanism that enhances mixing in a supersonic jet. The inclusion of one or more swirl-generating vanes or fluidic devices or other structure in, at, or near the nozzle exit will trigger the centrifugal instability in a shear layer, thus promoting mixing. In a particular example, a cascade of vanes is attached to the inner wall of the divergent portion of a convergent-divergent nozzle, near the nozzle exit plane. The swirl vanes inside the nozzle penetrate the flow by a fraction of the nozzle radius to minimize the thrust loss.

Jet engines produce thrust through the combustion of jet fuel in an air mixture. The combustion results in rapidly expanding gases that emerge from the exhaust nozzle and propel the vehicle forward. As the gases exit the jet nozzle, however, the expanding gases create soundwaves that propagate through the atmosphere. The soundwaves from the jet engines are undesirable in civilian or military aircraft. In civilian aircraft, noise at airports near residential or commercial populations may be unpleasant to those individuals in the area. In military aircraft, high-intensity jet noise during takeoff, climb, approach and landing and flyover is undesirable for the personnel on carrier ships as well as military personnel on airbases. High-intensity noise in addition to radar and thermal signature degrades stealth and contribute to aircraft detection.

Jet noise is produced by a combination of turbulent mixing noise, a broadband shock-associated noise (BBSAN), and screech tones. The sound that emanates from the exhaust jet is audible to observers, sensors, and equipment, and is characterized by propagating pressure waves from the jet to the surrounding air. Shock cell structure and turbulence interaction amplify the noise emanating from the jet. In some embodiments, imparting an azimuthal or rotational motion (e.g., swirling) of the jet can promote jet mixing with the surrounding air and thus reduce jet noise. The rotational inertia of the jet causes the shear layer at the exterior of the jet to have an outward component, mixing the jet with the surrounding air. By increasing the jet mixing with the surrounding air, the kinetic energy of the jet is dissipated more readily, and the harmonics in the jet that contribute to jet noise are diminished. Furthermore, by enhancing jet mixing with the surrounding air, the hot exhaust gases can be cooled off by the surrounding air faster, thereby reducing thermal signature of the jet exhaust, as well.

In some embodiments, a swirl layer can be introduced by inducing rotation in the jet as a whole. In some embodiments, a swirl layer can be introduced by inducing rotation in an outer shear layer of the jet. For example, the swirl layer may be confined to less than 10% of a radius of the jet at the exit of the jet nozzle. In other examples, the swirl layer may be confined to less than 5% of the radius of the jet at the exit of the jet nozzle. In some embodiments, the swirl layer is a rotating layer of hot gas exiting from the nozzle. In some embodiments, the swirl layer is a rotating layer of cold gas that envelopes the jet around a circumference of the jet at the exit of the jet nozzle.

As used herein, a hot gas is a gas that is produced inside the jet and is part of the jet exhaust emerging from the aircraft engine. The aircraft engine or the jet engine may be gas turbine (GT) based or ramjet (RJ) based. A cold gas should be understood to be any gas that is introduced to the jet or the swirl layer after the combustion chambers in the jet engine. Examples of cold gases can include atmospheric gases external to the jet that are introduced after the jet exits the exhaust nozzle, cold gases that are introduced after the turbines in GT, or downstream of the combustors in RJ, through intakes in a housing of the turbine, cold gases that are introduced into the jet engine through an annular volume around the hot gases, or other gases or cooling streams not directly exhausted by the turbine in GT or downstream of combustors in RJ.

In some embodiments, a jet engine includes a convergent-divergent (C-D) nozzle at a rear exit of the jet engine. A C-D nozzle includes a convergent portion and a divergent portion arranged longitudinally proximate the exit of the jet engine. An inner diameter (ID) of the engine decreases (i.e., converges) in the direction of jet flow (i.e., toward the exit of the nozzle) during the convergent portion, and the ID of the engine increases (i.e., diverges) during the divergent portion, which follows the convergent portion in the direction of jet flow. The throat of the C-D nozzle is positioned between the convergent portion and divergent portion, and the throat is the location or region of the nozzle with the smallest ID. A convergent-divergent nozzle may be of rectangular cross section which is suitable for system integration, and vector thrust capability that leads to super-maneuverability. In the convergent portion, the flow cross sectional area decreases up to the throat and then flow cross sectional area increases downstream of the throat and up to the nozzle exit.

Embodiments of a C-D nozzle with swirl vanes, according to the present disclosure, may have the swirl vanes positioned on the inner surface of the nozzle to induce rotation of the hot gases therein, as the hot gases flow through the nozzle. In some embodiments, the swirl vanes are located in the convergent portion. In some embodiments, the swirl vanes are located in the divergent portion. In some embodiments, the swirl vanes are located on an outer surface of the nozzle to induce swirl in a swirl layer of cold gas outside of the jet nozzle that creates a rotating envelope around the hot gases as the hot gases exit the nozzle. In embodiments with swirl vanes on an outer surface of the jet nozzle, the swirl vanes can be positioned longitudinally along the outer surface of the nozzle afterbody, such that the swirl vanes are located longitudinally on the nozzle afterbody in the vicinity of nozzle exit plane. In some embodiments, swirl vanes can be arranged annularly in a ring on the inner surface and/or the outer surface of the jet nozzle. In some embodiments, swirl vanes can be distributed longitudinally in a plurality of annular rings, or in an array of vanes on the inner surface and/or outer surface.

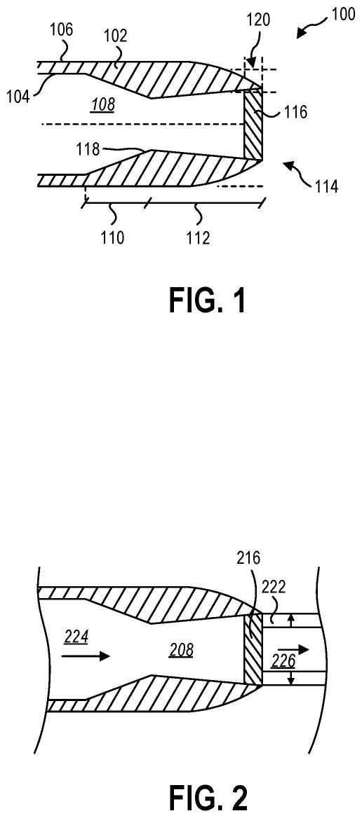

FIG. 1 illustrates an embodiment of a C-D jet nozzle 100. The C-D jet nozzle 100 has a nozzle body 102 with an inner surface 104 and an outer surface 106. The inner surface 104 defines an inner volume 108 through which the jet flows. The jet flows through the inner volume 108 from proximate the convergent portion 110, past proximate the divergent portion 112, and out the jet nozzle exit 114. In the illustrated embodiment of FIG. 1, the jet nozzle 100 includes a plurality of swirl vanes 116 located adjacent to the jet nozzle exit 114 at the terminal end of the divergent portion 112 after the throat 118 of the jet nozzle 100. In some embodiments, an ID of the throat 118 is less than 90% of the ID of the exit 114. In some embodiments, the ID of the throat 118 is between 80% and 90% of the ID of the exit 114.

The swirl vanes are located in a swirl vane region 120. In some embodiments, the swirl vane region 120 has a longitudinal length that is less than 50% of the divergent portion 112 longitudinal length. In some embodiments, the swirl vane region 120 has a longitudinal length that is less than 25% of the divergent portion 112 longitudinal length. In some embodiments, the swirl vane region 120 has a longitudinal length that is less than 10% of the divergent portion 112 longitudinal length.

In some embodiments, the swirl vane region 120 has a longitudinal length that is less than 50% of the diameter of the exit 114. In some embodiments, the swirl vane region 120 has a longitudinal length that is less than 25% of the diameter of the exit 114. In some embodiments, the swirl vane region 120 has a longitudinal length that is less than 10% of the diameter of the exit 114.

As the longitudinal length of the swirl vane region 120 decreases the drag on the jet decreases, increasing net thrust of the engine. In some embodiments, a greater longitudinal length of the swirl vane region 120 can impart more rotational inertia efficiently to the jet, promoting jet mixing, while a shorter longitudinal length of the swirl vane region 120 imparts rotation to the jet, albeit less efficiently. In some embodiments, rotational inertia of the exterior of the jet promotes jet mixing, and rotation of the partial or the entire jet may not be necessary to effectuate improved jet mixing.

The swirl vanes 116 are positioned at a pitch relative to the longitudinal flow direction of the gases, and the swirl vanes 116 induce a rotation to the swirl layer as the gases move over and in between the vanes. In some embodiments, the pitch of the swirl vanes 116 is in a range having an upper value, a lower value, or upper and lower values including any of 1°, 5°, 10°, 20°, 30°, 40°, 45°, 50°, 60°, 70°, 75°, or any values therebetween. For example, the pitch may be greater than 1°. In other examples, the pitch may be less than 75°. In yet other examples, the pitch may be between 1° and 75°. In further examples, the pitch may be between 10° and 60°. In at least one example, the pitch is between 30° and 50°.

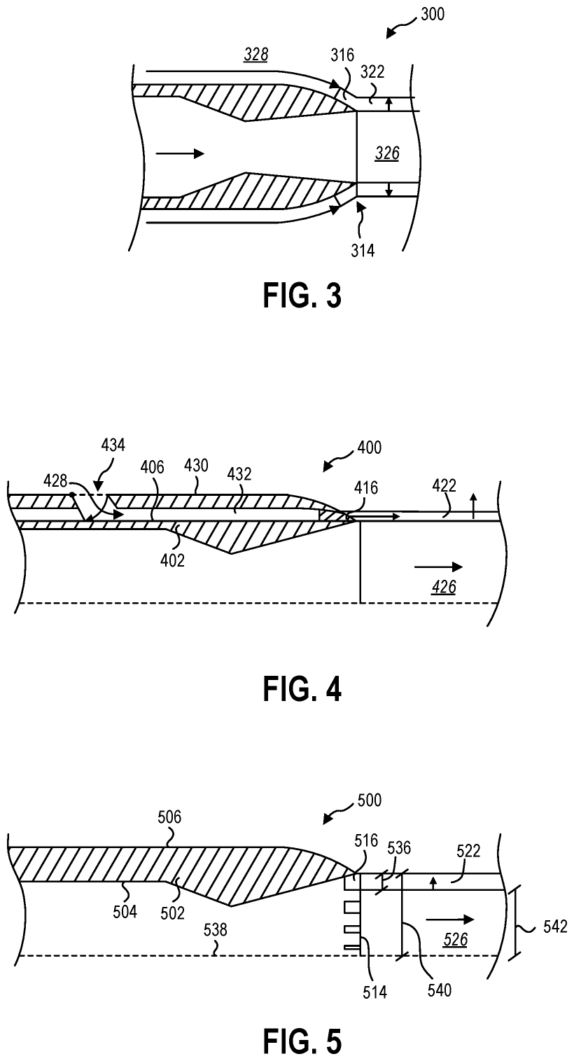

In some embodiments, the rotating swirl layer 222 is hot gas 224, such as in the embodiment illustrated in FIG. 2. The hot gas 224 moves through the interior volume 208, and at least an outer portion of the hot gas 224 encounters the swirl vanes 216. In some embodiments, the rotating swirl layer is cold gas from an exterior shear layer around and/or enveloping the jet 226. In some embodiments, the jet 226 has a jet core with a speed of at least Mach 0.8. In some embodiments, the jet 226 has a supersonic jet core with a speed of at least Mach 1.0. In some embodiments, the jet 226 has a jet core with a speed of at least Mach 1.4. In some embodiments, the jet 226 has a jet core with a speed of at least Mach 1.6. In some embodiments, the jet 226 has a jet core with a speed of at least Mach 1.8. In some embodiments, the rotating swirl layer includes cold gases, such as illustrated in the examples of FIG. 3 and FIG. 4 and core Mach numbers in subsonic to supersonic range.

FIG. 3 illustrates an embodiment of a jet nozzle 300 according to the present disclosure with swirl vanes 316 positioned on an outer surface 306 of the jet nozzle 300 proximate the exit 314 of the nozzle. The swirl vanes 316 are exposed to the cold gas 328 around the jet nozzle 300 and passing over the jet nozzle 300. The swirl vanes 316 induce a rotation in a shear layer of the cold gases surrounding the jet 326 after the jet 326 exits the jet nozzle 300. In some embodiments, the swirl layer 322 around the jet 326 imparts rotation to the jet 326 through fluidic drag and entrainment with the jet gases. In some embodiments, the swirl layer 322 disrupts and mixes the jet 326 in part due to the pressure differentials created by the radially outward component of the swirl layer's rotational inertia.

FIG. 4 illustrates another embodiment of a jet nozzle 400 according to the present disclosure. The jet nozzle 400 includes an outer layer 430 around the jet nozzle body 402. An outer channel 432 is provided between the jet nozzle body 402 and the outer layer 430. In some embodiments, the outer channel 432 is an annular channel that surrounds the jet nozzle body 402. In some embodiments, the outer channel 432 is one or more discrete channels that allow fluid flow on an outer surface 406 of the jet nozzle body 402.

In some embodiments, the outer channel(s) 432 allow flow of cold gas 428 therethrough. In some embodiments, the outer channel(s) 432 allow flow of atmospheric gas therethrough. The outer layer 430 may selectively allow intake of cold gases 428 into the outer channel(s) 432. For example, the outer layer 430 may include actuatable intake valves 434 that control the flow through the outer channel(s) 432. In some embodiments, the intake valves 434 can be opened to intake air and flow the air through the outer channel(s) 432 and through/over variable pitch swirl vanes 416 located in the outer channel(s) 432. The swirl vanes 416 can, thereby, induce rotation to a cold swirl layer 422 around the jet 426 gases. By selectively allowing gas into the outer channel(s) 432, or actuating the variable pitch swirl vanes, the jet nozzle 400 can open the intake valves 434 to promote jet mixing when lower jet noise and/or a lower thermal signature is desired, and the jet nozzle 400 can close the intake valves 434 to reduce swirl vane drag and thus increase thrust or position the variable-pitch swirl vanes in neutral, or swirl-free position.

Referring now to FIG. 5, in some embodiments, swirl vanes 516 have a height 536 in a direction perpendicular to the longitudinal axis 538 of the jet nozzle 500, whether the swirl vanes 516 are positioned on an inner surface 504 of the jet nozzle body 502, the outer surface 506 of the jet nozzle body 502, on a surface of an outer layer (such as outer layer 430 described in relation to FIG. 4), or on another surface of the jet nozzle 500. The vane height 536 may affect the size of the swirl layer 522 relative to the size of the jet 526. The vane height 536 is relative to the radius 540 of the jet 526 exhausted through the exit 514 of the jet nozzle 500. For example, a greater vane height 536 may produce a larger swirl layer 522 relative to the jet radius 540 and produce more drag on the jet 526. A smaller vane height 536 relative to the jet radius 540 may produce a thinner swirl layer 522 relative to the jet radius 540 and less drag on the jet 526 allowing for greater thrust. In the case of a C-D nozzle with rectangular cross section, the principle remains the same, and the effective radius or hydraulic diameter of the nozzle cross section is used in comparison to vane height.

In some embodiments, the vane height 536 is a percentage of the exit jet radius 540 in a range having an upper value, a lower value, or upper and lower values including any of 1%, 5%, 10%, 15%, 20%, 25% or 30%. In some examples, the vane height 536 is greater than 1% of the exit jet radius 540. In other examples, the vane height 536 is less than 30% of the exit jet radius 540. In yet other examples, the vane height 536 is between 1% and 30% of the exit jet radius 540. In further examples, the vane height 536 is between 5% and 20% of the exit jet radius 540. In at least one embodiment, the vane height 536 is about 10% of the exit jet radius 540. In C-D nozzles with rectangular cross section, vane heights may vary between 1% to 30% of the nozzle exit hydraulic radius.

FIG. 5 is a side cross-sectional view of an embodiment of a jet nozzle 500. The swirl layer height is approximately the same as the vane height 536, such that an increase in the vane height 536 would produce an increase in the swirl layer thickness. In the illustrated example, increasing the swirl layer thickness simultaneously reduces the non-swirling volume 542 of the jet 526. In other embodiments, such as a swirl layer 522 of cold gas around the jet 526, the swirl layer 522 can be increased without altering the non-swirling volume 542 of the jet 526.

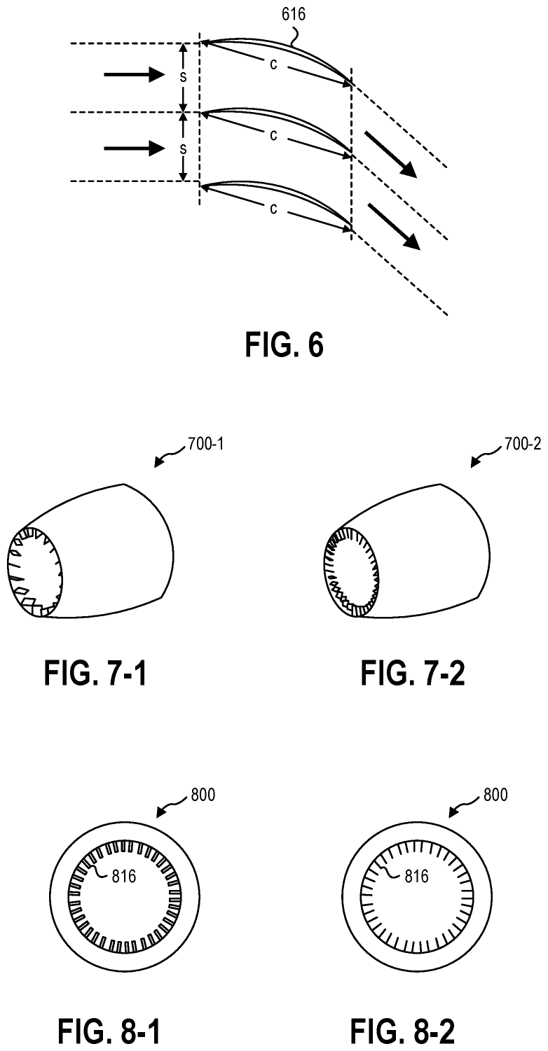

Various embodiments may have different vane solidities in the jet nozzle for creating a swirl layer. FIG. 6 is a schematic illustration of vane solidity. The vane solidity is a measure of how much force each vane 616 can apply to the air moving across the vane 616 to change the direction of the air. The vane solidity is a ratio relating vane chord length (c) relative to the spacing (s) between the vanes. In other words, making the vanes 616 longer by increasing the chord length (e.g., the length of the vane from the leading edge to the trailing edge) increases vane solidity or equivalently, reducing vane spacing increases the vane solidity.

In some embodiments, the solidity is 0.5 and in some embodiments the solidity is 1.0 and in some embodiments the solidity is 2.0. Higher solidity imparts swirl more efficiently but at the cost of higher drag and thus thrust loss. The swirl generation efficiency is reduced with decreasing solidity, but thrust loss is decreased as well. Depending on the application, from axisymmetric to rectangular nozzle geometry, and the jet Mach number, and the jet temperature ratio the optimal swirl angle and the vane solidity differs.

FIG. 6 is a side view of the vanes 616, illustrating an embodiment of a vane shape with a non-constant arc relative to the longitudinal direction of the flow. In some embodiments, the vane shape includes or is a circular or parabolic arc. In some embodiments, the vane shape includes or is a double- or multiple-circular arc. In some embodiments, the vane shape includes compression-expansion ramps, or is a linear surface without an arc. In some embodiments, the vane shape includes or is a surface with an exponential curve.

Similarly, stator solidity is a measure of the amount of the area through which the jet passes that the vanes occupy. Commonly, the rotor solidity is used in reference to blades of a fan or rotor (such as a helicopter or propellor engine) that rotate to move air axially. In the present instances, the air is moving axially relative to the swirl vanes, which act as a stator to impart a rotation to the air. While the reference frame is changing, the principle remains the same.

In embodiments with swirl vanes located on the inner surface of the jet nozzle body, the stator or vane solidity is the percentage of a disc through which the jet passes that is occluded or otherwise occupied by the swirl vanes. For example, FIGS. 7-1 and 7-2 illustrate example embodiments of jet nozzles 700-1 and 700-2 with different stator solidities. The embodiment of a jet nozzle 700-1 illustrated in FIG. 7-1 has a lower solidity than the embodiment of a jet nozzle 700-2 illustrated in FIG. 7-2. As the solidity increases, the amount of rotation imparted to the swirl layer may increase, thereby increasing jet mixing attributable to the swirl layer. However, increases in stator or vane solidity can also increase drag on the jet, which is called thrust penalty. Depending on the application, from axisymmetric to rectangular nozzle geometry, and the jet Mach number, and the jet temperature ratio the optimal swirl angle and the vane solidity differs.

In some embodiments, at least some of the swirl vanes are selectively deployable. A deployable vane may be movable between a 0° pitch and a non-zero degree pitch, where the 0° pitch is considered “stowed” as a 0° pitch reduces and/or eliminates swirl in the gases passing over/through the vanes. A non-zero degree pitch is considered to be “deployed”, as the non-zero degree pitch imparts a lateral force to the gases passing over/through the vanes to produce a swirl layer. In some embodiments, the vanes are deployable from a flush position in which the vane lays flat against and/or in the surface (e.g., inner surface of the jet nozzle body, outer surface of the jet nozzle body, surface of an outer channel) on which the vane is positioned. When the vane is laid flat against the surface, the vane is stowed and provides little to no lateral force to the gases passing over the vane. When raised at a non-zero-degree angle to the surface, the vane may impart a lateral force and produce a swirl layer.

FIGS. 8-1 and 8-2 illustrate an embodiment of a jet nozzle 800, according to the present disclosure, with a plurality of swirl vanes 816 in a deployed state and in a stowed state, respectively. The deployed state illustrated in FIG. 8-1 increases the stator solidity and generates a swirl layer in the jet that passes axially through the jet nozzle 800 and past the swirl vanes 816. In at least one example, the plurality of swirl vanes 816 is actuated to the deployed state of FIG. 8-1 during takeoff, climb, approach, or landing, when mitigation of jet noise is desired. At altitude, when noise is of less concern and engine thrust and/or efficiency is prioritized, the plurality of swirl vanes 816 may be actuated to the stowed state illustrated in FIG. 8-2 in which the plurality of swirl vanes 816 imparts little to no net force or rotation on the jet. While FIGS. 8-1 and 8-2 show a binary comparison of a deployed state and a stowed state, it should be understood that the plurality of swirl vanes 816 may be moveable to a variety of pitch angles in the deployed state.

A variable pitch swirl vane may allow for control over the amount of rotation imparted to the swirl layer in or around the jet and allow the pilot or operator or the flight control system to balance the amount of noise mitigation with the thrust penalty on the jet. In some embodiments, a swirl vane is both deployable and variable in pitch. For example, a swirl vane may be rotatable to vary the pitch relative to the longitudinal direction, and the swirl vane may be actuated to a flush position on or in a surface of the jet nozzle to stow the swirl vane.

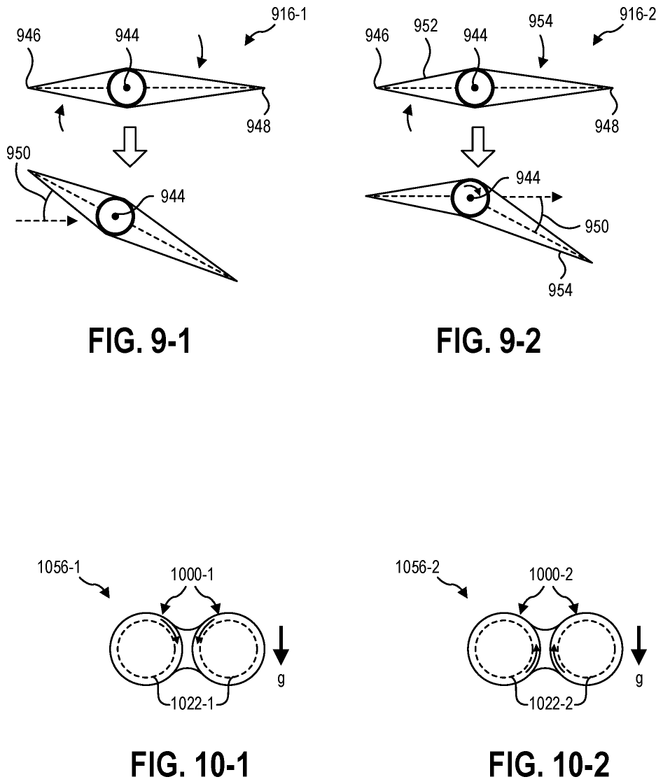

In embodiments of a jet nozzle with variable pitch swirl vanes, the swirl vanes may be rigid and rotatable around an axis to vary the pitch. In some embodiments, the swirl vane may have a first portion and second portion that are moveable relative to one another to vary the chord length and/or shape of the vane. FIG. 9-1 illustrates a rotatable swirl vane 916-1 that changes pitch 950 according to a rotation about a rotational axis 944. While the rotational axis 944 is depicted at a point between the leading edge 946 and the trailing edge 948 of the swirl vane 916-1, in some embodiments, the rotational axis 944 is positioned approximately at the leading edge 946 and/or the trailing edge 948.

FIG. 9-2 illustrates another embodiment of a swirl vane 916-2 with a first portion 952 including a leading edge 946 of the swirl vane 916-2 and a second portion 954 including a trailing edge 948 of the swirl vane 916-2 where the second portion 954 is moveable relative to the first portion 952. Moving the second portion 954 around a rotational axis 944 of the swirl vane 916-2 positioned between the first portion 952 and the second portion 954 allows the overall shape of the swirl vane 916-2 to change as needed. For example, the first state of swirl vane 916-2 illustrated in FIG. 9-2 may be a stowed state that allows for gases to pass over or by the swirl vane 916-2 without imparting significant force to the gases. The second state has a different shape with the second portion 954 oriented with a pitch 950 relative to the longitudinal direction to impart swirl to the fluid in its vicinity.

As described herein, swirl vanes according to the present disclosure may include any combination of the features described herein, and some embodiments may be selectively deployable, rotatable, or have portions that are independently deployable and/or rotatable relative to another portion. In some embodiments, the deployed state or portion in a deployed state may be oriented with any pitch relative to the longitudinal flow of gases described herein.

While embodiments and benefits of jet nozzles, which generate a swirl layer are described herein, additional jet mixing can be achieved by entrainment of multiple engines with jet nozzles according to the present disclosure. In some embodiments, a pair of engines include jet nozzles according to the present disclosure that induce swirl layers having opposite rotational directions. The complementary rotation of the two adjacent swirl layers causes an increase in the entrainment of the gas from the ambient air that promotes mixing and thus mitigates jet noise. In twin engine configurations, the effect of shear layer swirl in neighboring jets is amplified and thus leads to collaborative noise suppression.

FIGS. 10-1 and 10-2 are rear views of a pair of jet engines 1056-1, 1056-2 with complementary opposite rotations of swirl layers 1022-1, 1022-2. In some embodiments, such as illustrated in FIG. 10-1, the first jet nozzle and the second jet nozzle 1000-1 have vanes oriented in opposite rotational directions (or counter-rotating) such that the adjacent portion of the swirl layers 1022-1 both rotate downward relative to the direction of gravity (g). In some embodiments, such as illustrated in FIG. 10-2, the first jet nozzle and the second jet nozzle 1000-2 have vanes oriented in opposite rotational directions (still counter-rotating) such that the adjacent portion of the swirl layers 1022-2 both rotate upward relative to the direction of gravity (g).

While embodiments of jet nozzles including swirl vanes to induce swirl layers to enhance jet mixing have been described herein, in some embodiments, other swirl mechanisms in addition to or in alternative to the swirl vanes induce a swirl layer. For example, fluidic actuators may introduce gas into the jet at an angle to the longitudinal direction of jet flow. A fluidic actuator may be any fluid source, passive or active, that introduces a secondary flow of fluid into or around the jet. Fluidic actuators according to the present disclosure may be positioned at any location described herein in relation to swirl vanes, such as but not limited to the inner surface of the jet nozzle body, an outer surface of the jet nozzle body, or an outer channel outside of the jet nozzle body. The fluidic actuators may be added and coupled with the operation of the swirl vanes to enhance jet noise mitigation.

In some embodiments, the fluidic actuator may be oriented with a pitch angle such that fluid exiting the fluidic actuator enters the swirl layer at an angle equivalent to any of the pitch angles described herein. In some embodiments, the pitch of the fluidic actuator is in a range having an upper value, a lower value, or upper and lower values including any of 1°, 5°, 10°, 20°, 30°, 40°, 45°, 50°, 60°, 70°, 75°, or any values therebetween. For example, the pitch may be greater than 1°. In other examples, the pitch may be less than 75°. In yet other examples, the pitch may be between 1° and 75°. In yet other examples, the pitch is between 10° and 60°. In at least one example, the pitch is between 30° and 50°. In some embodiments, the pitch is variable.

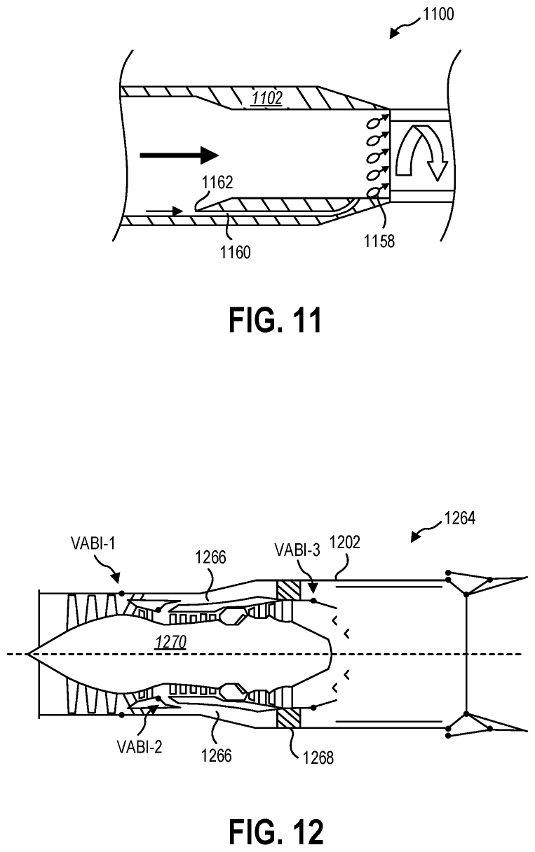

FIG. 11 is a side cross-sectional view of an embodiment of a jet nozzle 1100 with a plurality of fluidic actuators 1158. In some embodiments, the fluidic actuators 1158 receive fluid from a dedicated source, such as the inlet bypass, fan duct bypass, mixer bypass and other fluid sources onboard the aircraft. In other embodiments, such as illustrated in FIG. 11, the fluidic actuators 1158 receive gas from the jet through a conduit 1160 in the jet nozzle body 1102. An inlet 1162 diverts a portion of the hot gases from the jet through the conduit 1160, which changes the orientation of the flow for that diverted portion of the jet, before reintroducing the diverted or bypassed portion at the pitch angle to induce a swirl layer. In other embodiments, similarly to the outer channel 432 described in relation to FIG. 4, a conduit 1160 receives cold gas outside of the jet nozzle body 1102 and diverts a portion through conduit 1160 to the fluidic actuator 1158. The fluidic actuator 1158 can then introduce the cold gas to the jet 1126 to induce a swirl layer 1122. Similar to as described in relation to the outer channel of FIG. 4, a valve may selectively control flow through the conduit 1160, as an ejector nozzle, to the fluidic actuator 1158 to modulate (i.e., enable, disable, or partially enable) the swirl layer 1122.

Some engine designs include variable fluid flow paths and areas inherently in the engine design. Inclusion of swirl mechanisms, such as swirl vanes or fluidic actuators as described herein, can be implemented in such existing designs with little impact to the engine performance, system integration, or controls. The ability to change the type, i.e., the character, of a jet engine within its flight envelope is highly desirable. An example of such an engine is called an Adaptive Cycle Engine (ACE). For example, the Pratt and Whitney J58 that powered the SR-71 Blackbird included different operational regimes depending on altitude and speed. The aircraft has a broad speed range, from zero at takeoff to Mach 3+ at cruise. The ACE used propelled the aircraft with the engine as an afterburning turbojet up to Mach 2.0 and, by opening a compressor bleed system to feed the afterburner up to Mach 3+, allowed the engine to operate similar to a ramjet at high speed.

Sustainability in the context of military aircraft, as a new/modern concept, means to accomplish a given mission by the least possible fuel burn and the least environmental impact including both exhaust emissions and noise generated by the engine(s). To accomplish this, the airflow distribution, for thrust and power production as well as vehicle thermal management, is managed and controlled within the engine. In a conventional mixed-flow turbofan engine with a fixed-geometry format, the overall cycle pressure ratio is governed by the fixed geometry fan duct, core size, and the turbine backpressure. A jet nozzle with selectively controllable swirl mechanisms may allow an otherwise fixed geometry engine to have multiple operating modes.

An ACE requires a system of valves, known as Variable Area Bypass Injectors (VABI), at key locations in the propulsor that allow for optimal use of airflow in thrust/power production and thermal management. A schematic drawing of a candidate variable-bypass afterburning turbofan engine is shown in FIG. 12. The ACE 1264 uses a combination of VABI-1, VABI-2, and VABI-3 to control gas flow through different portions of the ACE 1264. For example, through different combinations of opening and closing the VABIs, the ACE 1264 can direct flow through or around different areas of turbines within the engine. The VABIs can also open bypass channels 1266 which may function similar to the outer channels described herein.

In some embodiments, swirl mechanisms 1268 can be positioned in the bypass channels 1266 and/or in the jet nozzle body 1202 to induce swirl layers and could be of variable-pitch design. The swirl layers can then be selectively induced by changing the VABIs and the variable-pitch swirl vanes. In some embodiments, the swirl layers can be automatically induced when the ACE 1264 changes operational modes. For example, when the VABI-1 opens to allow a portion of the gases to bypass the second half of the rotor 1270, swirl mechanisms 1268 in the bypass channel 1266, upon deployment, can induce a swirl layer in the bypass channel 1266. The swirl layer can then re-enter the main jet after the rotor 1270 to enhance jet mixing after the jet and swirl layer exit the ACE 1264. In this manner, the ACE 1264 automatically initiates a swirl layer based on placement of the variable-pitch swirl mechanisms 1268 in an existing ACE 1264 design, which may further improve noise performance of the ACE 1264 in low noise and/or low emissions, or low-observable, operational modes. The swirl vanes 1268 may be of variable pitch design which has the capability of zero swirl when the engine operation demands to finite swirl in engine operating modes that benefit from partially swirling flow through the engine mixer and nozzle.

Experimental models and collected data from prototypes indicate improved acoustic performance in each of the contributing components of the jet engine noise: a turbulent mixing noise, a broadband shock-associated noise (BBSAN), and screech tones. Turbulent mixing noise is caused by the turbulence in the mixing or shear layer of the jet and is the dominant noise source in the downstream direction. Broadband shock associated noise is generated by turbulent eddies passing through the shock-cell system of an under-expanded supersonic jet plume. Finally, screech is a resonant feedback phenomenon created by the interaction of large-scale turbulent structures and shock cells. Introducing the swirl layer around the jet as the jet exists the nozzle speeds the jet mixing to reduce the turbulent mixing noise and disrupt the shock-cell system and plume to reduce all three components.

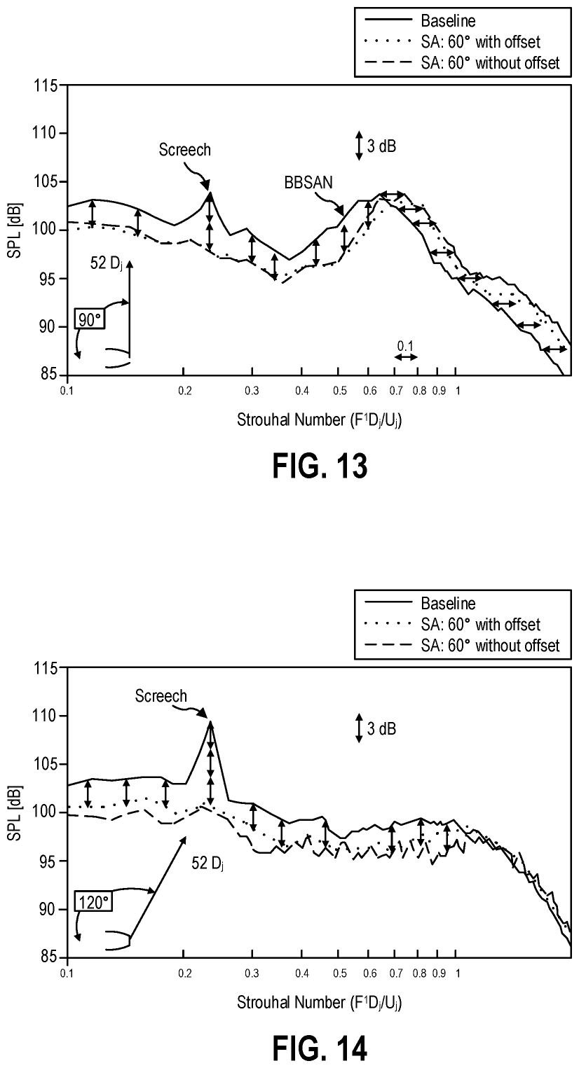

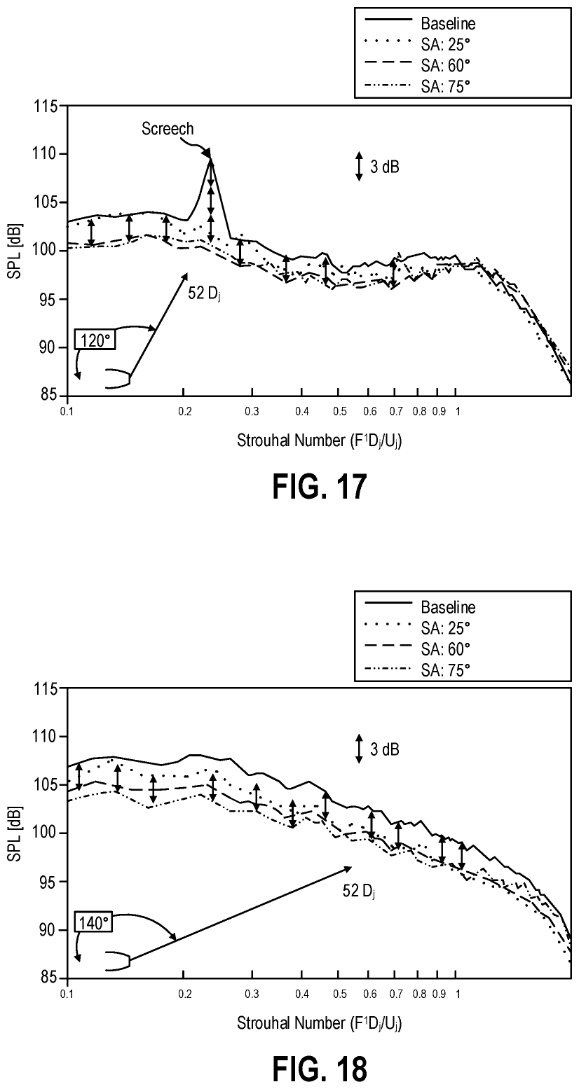

FIG. 13 through FIG. 18 are graphs illustrating experimental results of jet nozzles including swirl mechanism according to the present disclosure. FIG. 13 through 16 illustrate the noise mitigation using a jet nozzle with a 60° swirl angle at different observer positions relative to the jet direction. FIG. 17 and FIG. 18 illustrate the noise mitigation with swirl vanes at a variety of swirl vane angles measured at different observer positions relative to the jet direction. The graphs illustrate the jet noise intensity (expressed in decibels) in relation to the jet noise frequency (represented by dimensionless Strouhal number). The graphs all show a significant reduction in overall noise intensity over a broad frequency range, with a particularly pronounced reduction in screech tones and BBSAN. The relative scale of 3 dB is shown to signify 50% reduction in acoustic power in the jet.

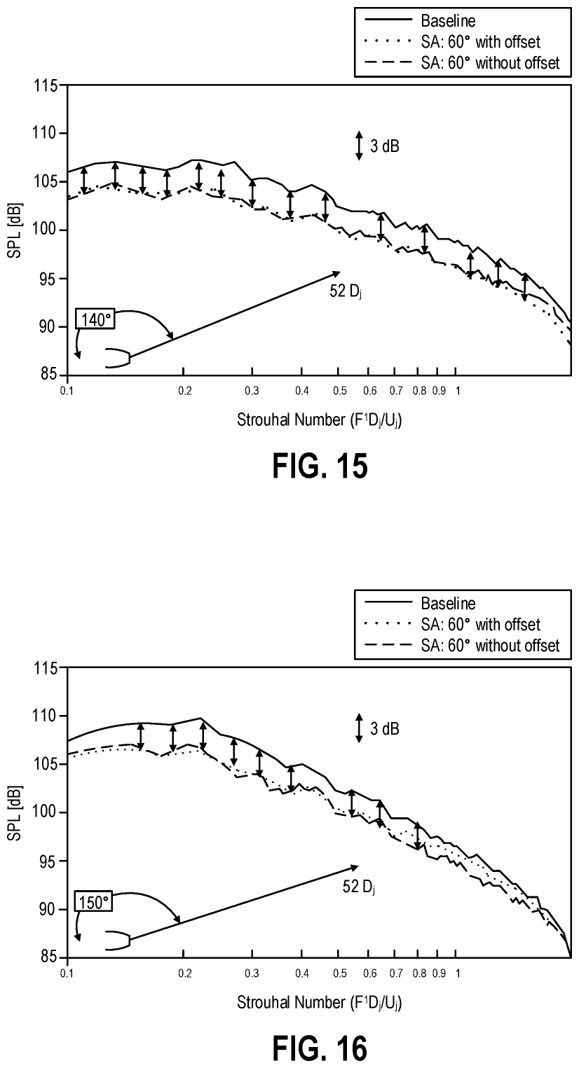

FIG. 13 through FIG. 16 illustrate the noise mitigation measured from observer positions at 90°, 120°, 140° and 150° orientations to the jet. FIG. 13 and FIG. 14 show that the screech tones are most pronounced in the baseline measurements when the observer is between 90° and 120°. However, the swirl mechanism of the jet nozzle significantly reduces the acoustic power in of the jet at the screech tones. Additionally, the swirl mechanism of the jet nozzle significantly reduces the sound pressure level (SPL) in the BBSAN region of the graph. FIG. 15 and FIG. 16 illustrates the noise mitigation at 140° and 150°, respectively, relative to the jet. The graphs both illustrate an overall decrease in SPL across the full measured range of Strouhal numbers. At least 50% reduction in acoustic power is demonstrated through the 3-dB rule imposed on the figures.

FIG. 17 and FIG. 18 illustrate the mitigation in jet noise at 120° and 140° relative to the jet, respectively. The curves in the graph reflect the measured SPL based on changes to the swirl vane angle. The variations in swirl vane angle produce shifts in noise mitigation levels at different frequencies, but noise reductions are measured across all Strouhal numbers even at a 25° swirl angle.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of reducing noise from a high-speed, including supersonic, jet, the method comprising:
providing the high-speed or supersonic jet in a longitudinal flow direction; and
inducing a rotation of a swirl layer of the high-speed or supersonic jet around a longitudinal direction of the jet and on the jet boundary so as to promote mixing of the high-speed or supersonic jet.

2. The method of claim 1, wherein a jet core of the high-speed or supersonic jet has a jet Mach number in transonic to supersonic range, i.e., Mach numbers in the range of 0.8 to 5.0.

3. The method of claim 1 or 2, wherein the mixing of the high-speed or supersonic jet reduces the noise produced by the high-speed or supersonic jet by at least 3 decibels.

4. The method any preceding claim, wherein the high-speed or supersonic jet passes through an exit, the rotation is induced at or near the exit, and the core flow including an outer region has substantially no rotation around the longitudinal direction prior to passing through the exit.

5. The method of any preceding claim, wherein the shear layer is less than 10% of a radius of the jet at the exit or hydraulic radius on rectangular nozzle configurations.

6. A device for reducing noise from a supersonic jet, the device comprising:
a jet nozzle having an exit therethrough, the exit having a longitudinal axis and configured to allow fluid communication therethrough; and
a swirl mechanism positioned on an inner surface of the jet nozzle configured to induce a rotation around a longitudinal direction of a fluid flowing through the exit in the longitudinal direction.

7. The device of claim 6, wherein the swirl mechanism includes a swirl vane oriented at an angle to the longitudinal direction.

8. The device of claim 7, wherein the swirl vane is oriented between 10° and 75° to the longitudinal direction.

9. The device of claim 7, wherein the swirl vane extends toward the longitudinal axis less than 10% of a radius of the exit or hydraulic radius on a rectangular nozzle configuration.

10. The device of claim 6, wherein the swirl mechanism includes a plurality of vanes oriented at an angle to the longitudinal direction, and the plurality of vanes has a solidity in the range of 0.5 to 2.0.

11. The device of claim 6, wherein the swirl mechanism includes a plurality of vanes arranged in a swirl vane region and oriented at an angle to the longitudinal direction, and the swirl vane region has a length in the longitudinal direction of preferably less than 50% of a diameter of the exit or its equivalent on a rectangular nozzle.

12. The device of claim 6, wherein the swirl mechanism includes a plurality of vanes oriented at an angle to the longitudinal direction, and the plurality of vanes having a vane angle between 10° and 75°.

13. The device of claim 6, wherein the swirl mechanism includes a plurality of vanes oriented at an angle to the longitudinal direction, and the vanes are selectively movable between a stowed state and partially or fully deployed state.

14. A system for propulsion comprising:
a jet engine having an exit, the jet engine configured to produce a high-speed or supersonic jet through the exit in a longitudinal direction; and
a swirl mechanism positioned proximate the outlet and at least partially in or adjacent to the high-speed or supersonic jet, wherein the swirl mechanism induces a rotation around the longitudinal direction of the high-speed or supersonic jet in a swirl layer of the high-speed supersonic jet.

15. The system of claim 14, wherein the swirl mechanism includes a fluidic actuator.

16. The system of claim 14, wherein the swirl mechanism is oriented between 10° and 75° to the longitudinal direction.

17. The system of any of claim 14, wherein the swirl mechanism is positioned on an inner surface of a nozzle of the jet engine.

18. The system of claim 17, wherein the swirl mechanism is positioned on a divergent portion of the inner surface.

19. The system of any of claim 14, further comprising a second jet engine having a second nozzle and configured to produce a second high-speed or supersonic jet through the second nozzle in the longitudinal direction parallel to the first supersonic jet, wherein the first supersonic jet has a first swirl layer rotation in a first direction and the second supersonic jet has a second shear layer rotation in a second direction opposite the first direction.

20. The system of claim 14, wherein the jet engine is an Adaptive Cycle Engine (ACE) and the variable-pitch swirl mechanism is positioned in bypass channel of the ACE.
